(19) United States
(12) Patent Application Publication
(10) Pub. No.: US 2008/0121002 A1
(43) Pub. Date: May 29, 2008

(54) DEADBOLT LOCK DEVICE WITH A REINFORCED HOUSING

(76) Inventors: Chia-Min SUN, Chiayi City (TW); Tsung-Chung HUANG, Chiayi County (TW); Cheng-Chung LIU, Chiayi County (TW)

Correspondence Address: LADAS & PARRY LLP, 224 SOUTH MICHIGAN AVENUE, SUITE 1600, CHICAGO, IL, 60604, US

(21) Appl. No.: 11/944,523

(22) Filed: Nov. 23, 2007

(30) Foreign Application Priority Data
Nov. 24, 2006 (TW) 095220898
Mar. 6, 2007 (TW) 096203712

(51) Int. Cl. E05B 65/06; E05B 15/00

(52) U.S. Cl. 70/124; 70/417

(57) ABSTRACT

A deadbolt lock device includes a housing having an inner case covered by an outer case, and an adaptor connected to the inner case. The inner case has an annular flange projecting inwardly from an open end thereof in a direction toward the adaptor, and an annular rib projecting transversely from the annular flange. The annular rib defines a through hole receiving a key-operated lock unit. The annular rib has an annular edge surrounding the lock unit and extends inclinedly from the juncture of the annular rib and the annular flange to the annular edge along directions inclining toward the open end. The annular rib is inclined with respect to a plane intersecting perpendicularly an axis of the lock case. The inclined annular rib provides an increased resistance to destructive forces.

### CROSS-REFERENCE TO RELATED APPLICATION

This application claims priority of Taiwanese Utility Model Application No. 095220898 filed on Nov. 24, 2006 and Taiwanese Utility Model Application No. 096203712 filed on Mar. 6, 2007.

### BACKGROUND OF THE INVENTION

1. Field of the Invention

This invention relates to a door lock, more particularly, to a deadbolt lock device mountable on a door.

2. Description of the Related Art

Exterior doors that permit exit and entry are usually provided with deadbolt locks which are used as auxiliary locks in addition to cylinder locks so as to enhance protection against burglary or illegal entry through the doors.

A typical deadbolt lock includes a deadbolt installed on a door panel, and two long screw rods that interconnect inner and outer lock units. The outer lock unit includes a key-operated lock that is operated by using a key from the outside of the door, whereas the inner lock unit includes a rotary knob that can be operated manually from the inside of the door. Examples of such deadbolt locks are disclosed in U.S. Pat. Nos. 5,540,070, 5,722,273, 5,216,910, 5,906,125, 6,230,528, and 5,335,525.

### SUMMARY OF THE INVENTION

An object of the present invention is to provide a deadbolt lock device with a reinforced structure that provides high resistance to destructive forces.

Accordingly, the present invention provides a deadbolt lock device for a door which comprises a key-operated lock unit having a lock case enclosing a key plug, and a housing receiving the lock case. The housing includes an inner case which has opposite first and second open ends, a first annular flange that projects inwardly from the first open end in a direction toward the second open end and that has an inner end extending away from the first open end, and a first annular rib that projects transversely from the inner end of the first annular flange. The first annular rib defines a through hole that receives the lock case. The first annular rib has an annular edge surrounding and disposed in proximity to the lock case, and first and second annular surfaces that are opposite to each other and that are interconnected by the annular edge. The first and second annular surfaces extend inclinedly to the annular edge from a juncture of the first annular flange and the first annular rib. The first and second annular surfaces are inclined with respect to a plane that intersects perpendicularly an axis of the lock case and that extends through the annular edge. The first and second annular surfaces extend inclinedly along directions inclining towards the first open end.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is an exploded view of the first preferred embodiment of the present invention;

FIG. 2 is an exploded view of the first preferred embodiment, which is viewed from a different position;

FIG. 3 is an elevation view of the first preferred embodiment;

FIG. 4 is a sectional view taken along line 4-4 of FIG. 3;

FIG. 5 is a sectional view of an inner case of the first preferred embodiment;

FIG. 6 is an enlarged view of a portion of the inner case;

FIG. 7 is an exploded view of the second preferred embodiment of the present invention;

FIG. 8 is a perspective view of the second preferred embodiment in an assembled state;

FIG. 9 is an elevation view of the second preferred embodiment in an assembled state;

FIG. 10 is a sectional view taken along line 10-10 of FIG. 9;

FIG. 11 is a sectional view of the inner case of the second preferred embodiment;

FIG. 12 is an enlarged view of a portion of the inner case of FIG. 11;

FIG. 13 is an exploded view of the second preferred embodiment in a different assembled configuration;

FIG. 14 is a perspective view of the second preferred embodiment of FIG. 13 in an assembled state;

FIG. 15 is an elevation view of the second preferred embodiment of FIG. 13 in the assembled state; and

FIG. 16 is a sectional view taken along line 16-16 of FIG. 15.

### DETAILED DESCRIPTION OF THE PREFERRED EMBODIMENTS

Before the present invention is described in greater detail, it should be noted that same reference numerals have been used to denote like elements throughout the specification.

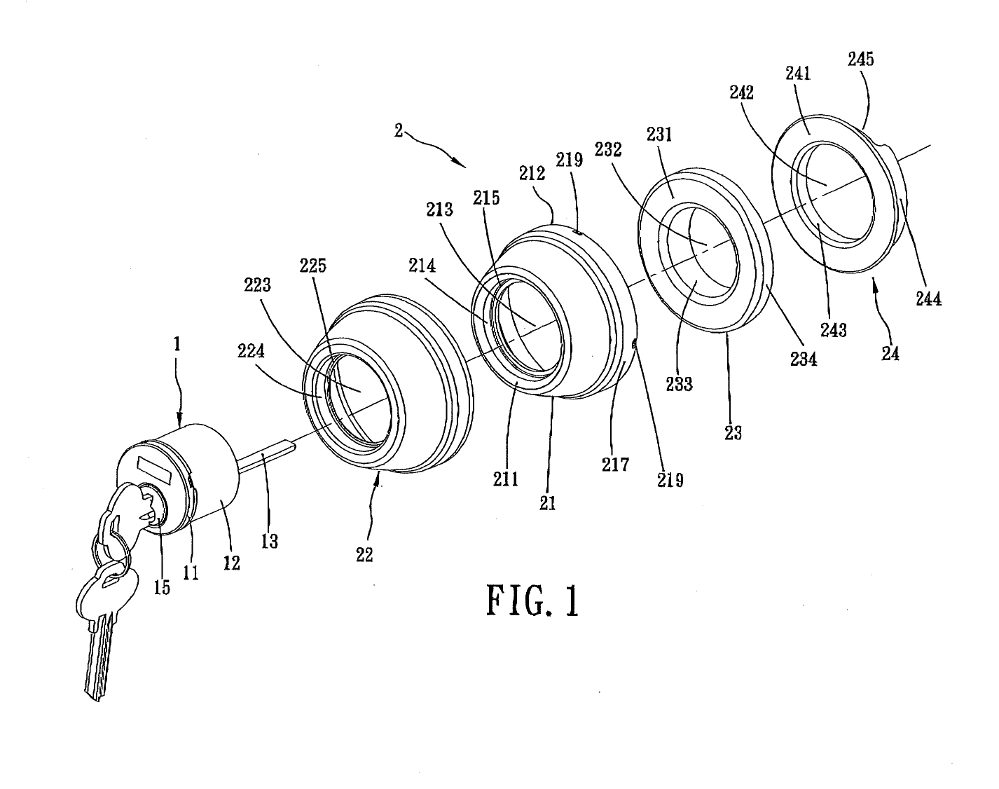

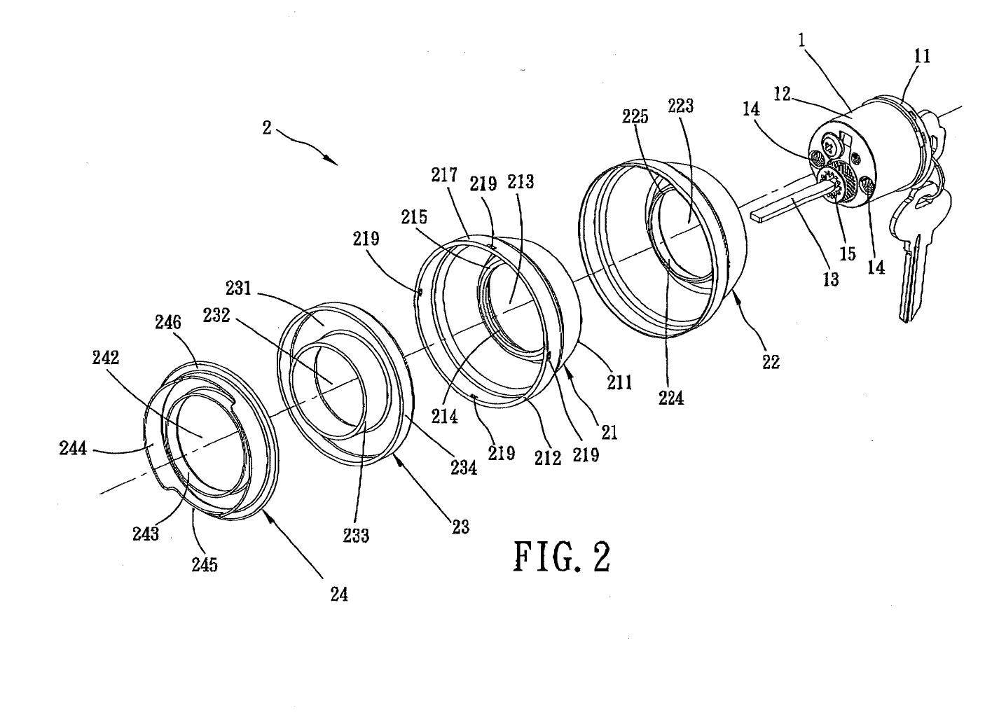

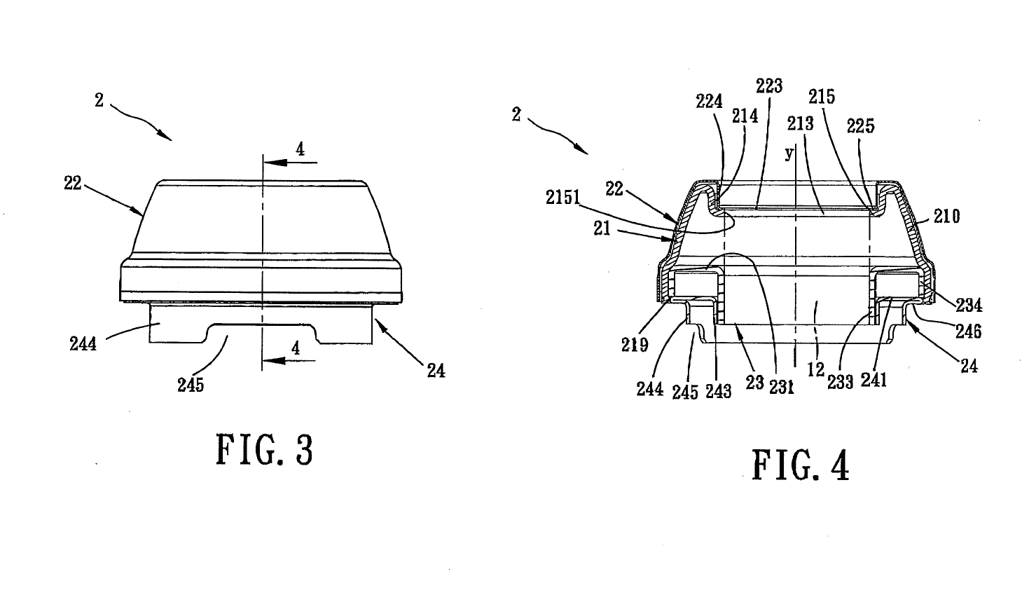

Referring to FIGS. 1-6, there is shown the first preferred embodiment of a deadbolt lock device according to the present invention. The deadbolt lock device is used as an auxiliary device for a door, and includes a key-operated lock unit 1 that is to be operated from the outside of the door when installed in the door, and a housing 2 enclosing the key-operated lock unit 1.

The key-operated lock unit 1 is known and includes a cylindrical lock case 12 formed with an annular flange 11, and a key plug 15 connected to a tailpiece 13 and disposed within the lock case 12.

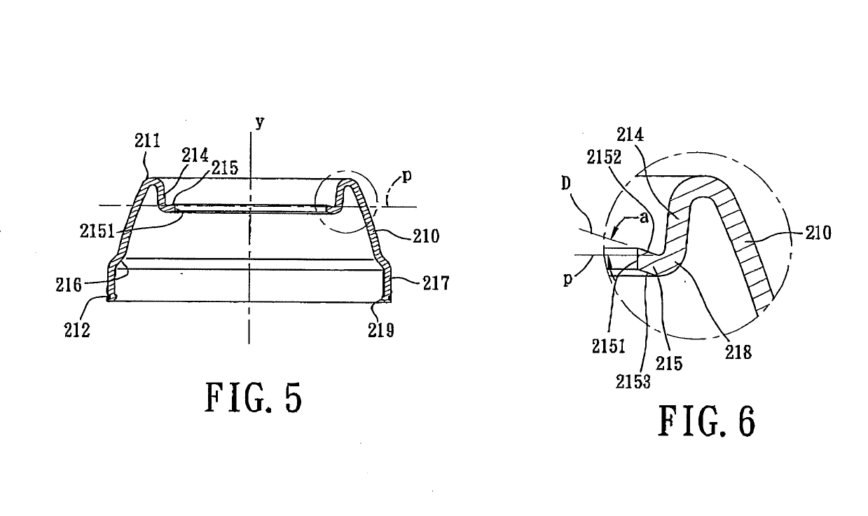

The housing 2 includes an inner case 21, an outer case 22, a reinforcing member 23, and an adaptor 24. The inner case 21 is a substantially conical hollow body formed from a metal plate. As best shown in FIGS. 4 and 5, the inner case 21 has opposite first and second open ends 211, 212, a substantially truncated cone-shaped wall section 210, a rim section 217, and an annular shoulder 216 interconnecting the wall section 210 and the rim section 217. The wall section 210 is tapered to the first open end 211. The rim section 217 extends from the annular shoulder 216 to the second open end 212. The rim section 217 has an inner annular surface. A plurality of angularly spaced apart bosses 219 project from the inner annular surface of the rim section 217 in close proximity to the second open end 212.

The inner case 21 further has a first annular flange 214 that projects inwardly from the first open end 211 in a direction toward the second open end 212 and that has an inner end extending away from the first open end 211, and a first annular rib 215 that projects transversely from the inner end of the first annular flange 214. The first annular rib 215 defines a central through hole 213.

The outer case 22 is also substantially conical and covers the wall section 210, the rim section 217, the first annular flange 214 and the first annular rib 215 of the inner case 21. The outer case 22 has a shape substantially similar to the inner case 21, and includes a central through hole 223 aligned axially with the through hole 213 of the inner case 21, a second annular flange 224 extending over the first annular flange 214, and a second annular rib 225 defining the through hole 223 and abutting against the first annular rib 215. The aligned through holes 213, 223 receive the lock case 12 of the key-operated lock unit 1.

The reinforcing member 23 is disposed within the inner case 21 and includes an inner tubular member 233 extending axially relative to the lock case 12 and defining a slot 232 aligned axially with the through hole 213 of the inner case 21, an outer tubular member 234 extending axially in proximity to the rim section 217 and around the inner tubular member 233, and an annular web 231 extending radially and connected to the inner and outer tubular members 233, 234. A portion of the inner tubular member 233 extends out of the second open end 212 of the inner case 21. The outer tubular member 234 abuts against the annular shoulder 216 and the inner annular surface of the rim section 217 and is engaged with the bosses 219. The inner tubular member 233 receives the lock case 12.

The adaptor 24 is connected to the inner case 21 in proximity to the second open end 212, and is adapted to be fitted in a mounting hole (not shown) formed in a door. The adaptor 24 includes an inner tubular member 243 defining a slot 242 aligned with the through hole 213 of the inner case 21, and is sleeved around the inner tubular member 233 of the reinforcing member 23. The inner tubular members 243 and 233 abut against each other, thereby increasing the resistance of the housing 2 to radial destructive forces.

An annular plate section 241 extends radially and outwardly from the inner tubular member 243. An outer tubular member 244 extends around the inner tubular member 243 and also extends out of the second open end 212 of the inner case 21. The outer tubular member 244 serves as a retaining member adapted to be fitted in the mounting hole (not shown) of the door. Two diametrically opposite notches 245 are formed in the outer tubular member 244 to receive and position a latch mechanism (not shown). An outer periphery of the annular plate section 241 has an annular folded and flattened plate end 246 that is formed as one piece with the annular plate section 241 and with the outer tubular member 244. The folded and flattened plate end 246 projects radially and outwardly from the outer tubular member 244 and abuts against the bosses 219 of the rim section 217 and the outer tubular member 234 of the reinforcing member 23.

The cylindrical lock case 12 extends through the through hole 213 in the inner case 21 and the slots 232 and 242 of the reinforcing member 23 and the adaptor 24. The annular flange 11 is surrounded by the first and second annular flanges 214, 224 and is engaged with the first and second annular ribs 215, 225. Screw holes 14 are provided to cooperate with fastening screw bolts (not shown) so as to install the lock case 12 in the door.

Referring back to FIGS. 4, 5 and 6, the first annular rib 215 has an annular edge 2151 surrounding and disposed in close proximity to the lock case 12, and first and second annular surfaces 2152, 2153 that are opposite to each other and that are interconnected by the annular edge 2151. Compared to a housing of the same type in the prior art, one of the differences of the housing 2 in the present invention is that the first and second annular surfaces 2152, 2153 extend inclinedly to the annular edge 2151 from a juncture of the first annular flange 214 and the first annular rib 215 and are inclined with respect to a plane (P) that intersects perpendicularly an axis (Y) of the lock case 12 and that extends through the annular edge 2151. The first and second annular surfaces 2152, 2153 extend inclinedly along directions (D) inclining towards the first open end 211.

Preferably, the first and second annular surfaces 2152, 2153 of the first annular rib 215 are inclined with respect to the plane (P) at an angle (a) of about 5 to 45 degrees. More preferably, the angle (a) is 20 to 30 degrees.

The inclined first annular rib 215 is provided to increase the resistance to destructive forces applied illegally by an unauthorized person, such as a thief. In particular, if a destructive force is applied to the housing 2 along an axial direction, the lock unit 1 will be forced to move inward, thereby pushing and deforming the first annular rib 215. When the first annular rib 215 becomes substantially parallel to the plane (P), the annular edge 2151 of the first annular rib 215 will contact tightly against the lock case 12 so that the lock case 12 will be stuck firmly in the through hole 213. The resistance to the destructive force will increase due to an increased tightness between the lock case 12 and the inner case 21. Contrary to the present invention, the housing in the prior art has an annular rib which is normally perpendicular to an axis of a lock case and which will deform and incline in a direction away from the first open end 211, when subjected to destructive forces, so that the lock case thereof can be loosened from the housing thereof.

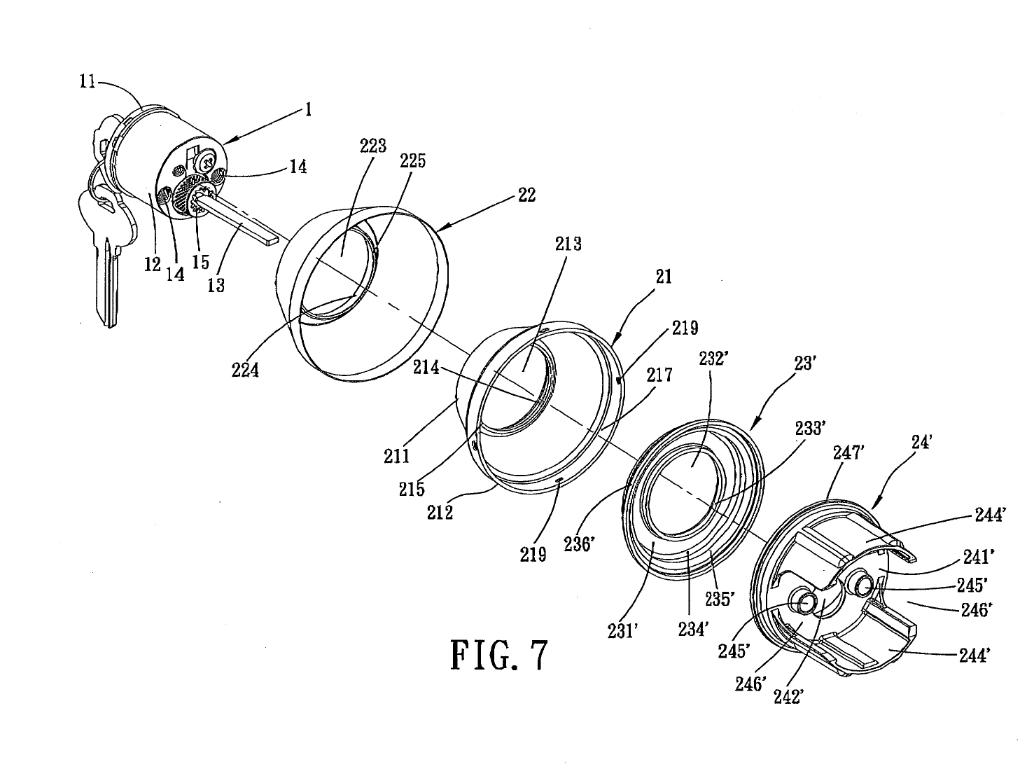

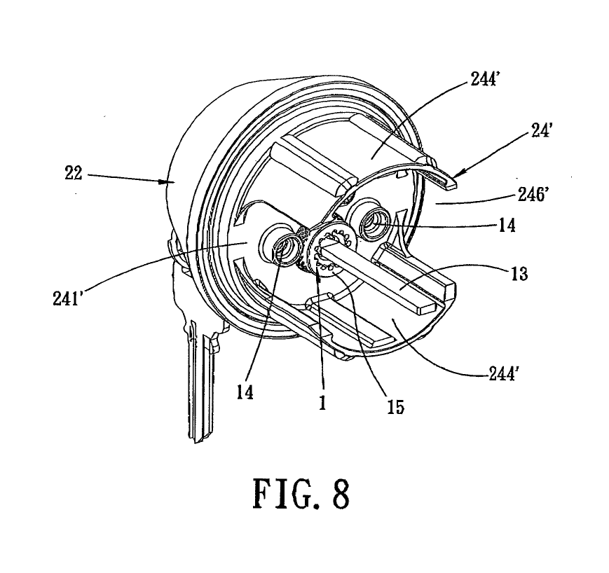

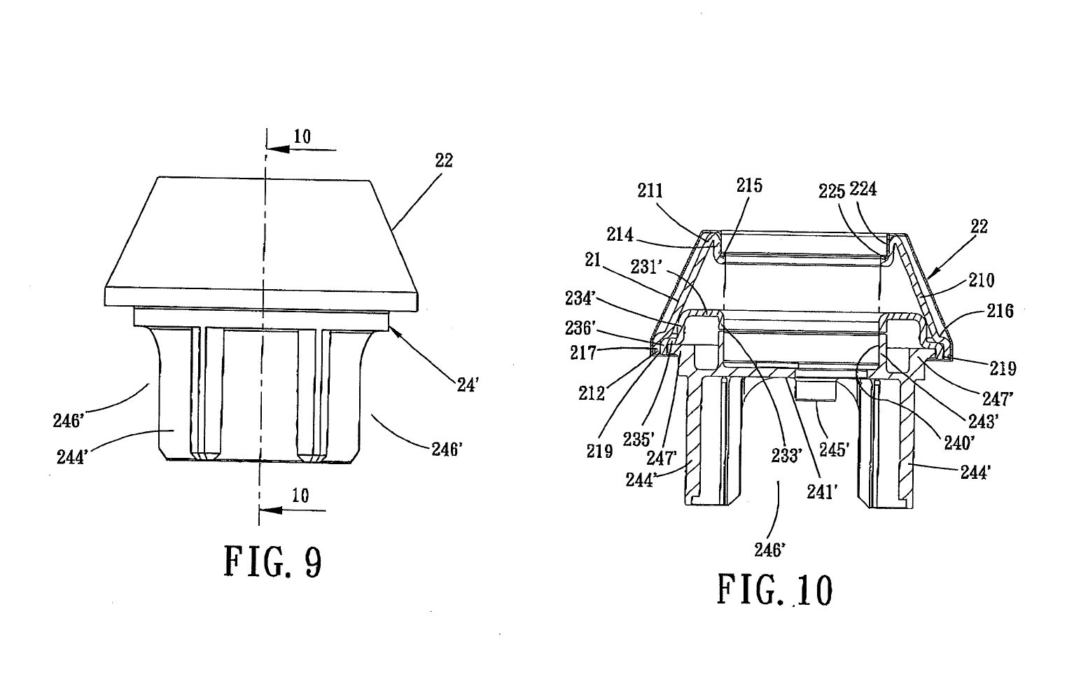

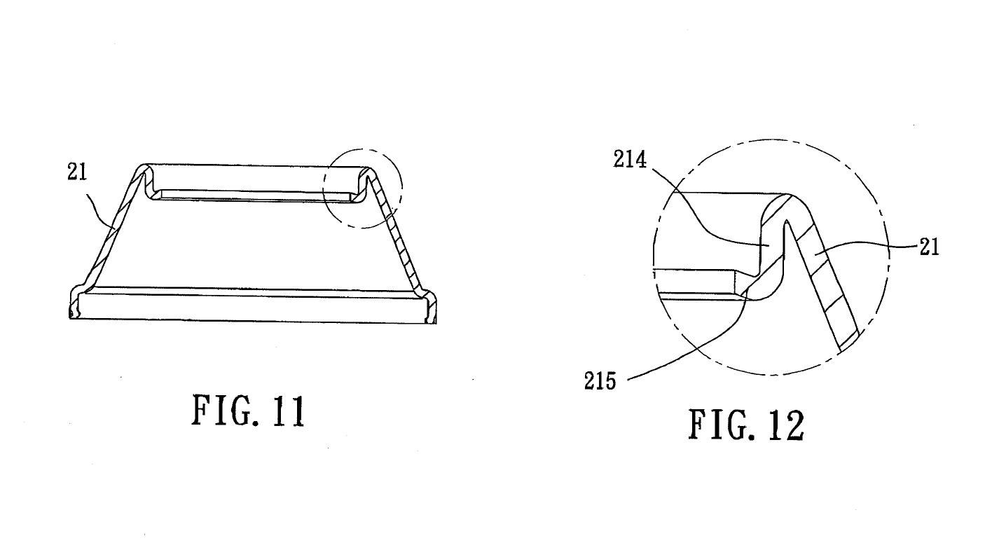

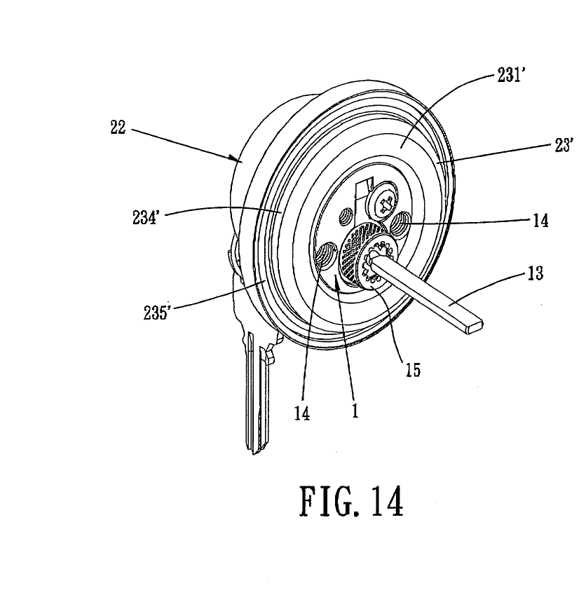

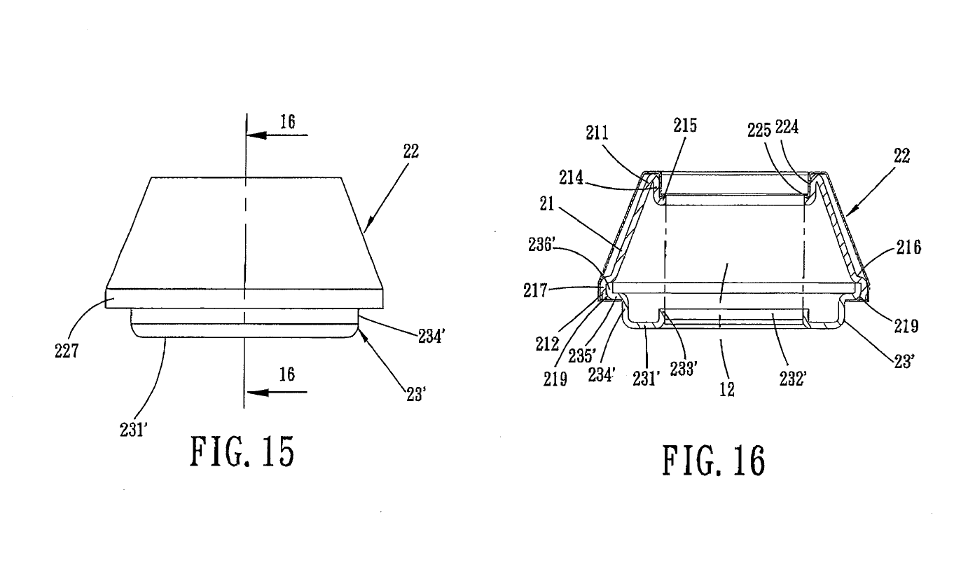

Referring to FIGS. 7-16, there is shown a second preferred embodiment according to the present invention. The second preferred embodiment differs from the first preferred embodiment in that the reinforcing member 23′ and the adaptor 24′ are used in the second preferred embodiment in place of the reinforcing member 23 and the adaptor 24.

As shown in FIGS. 7 and 10, the reinforcing member 23′ has an inner tubular member 233′ extending axially relative to the lock case 12 and defining a slot 232′ aligned axially with the through hole 213 of the inner case 21, an outer tubular member 236′ extending axially in proximity to the rim section 217, an outer annular web section 235′ extending inwardly and radially from the outer tubular member 236′ at a location proximate to the annular shoulder 216, an intermediate tubular member 234′ projecting axially from the outer annular web section 235′ to an inner surface of the wall section 210 of the inner case 21, and an inner annular web section 231′ extending radially and inwardly from the intermediate tubular member 234′ to the inner tubular member 233′ of the reinforcing member 23′.

The adaptor 24′ has an annular plate section 241′ disposed outwardly of the second open end 212 of the inner case 21 and having an opening 242′, an inner tubular member 243′ projecting axially into the rim section 217 from the annular plate section 241′ and defining a slot 240′, two diametrically opposite collar members 244′ projecting axially from the annular plate section 241′ in a direction away from the rim section 217, and an outer periphery having an outer peripheral lip 247′ extending outwardly from the annular plate section 241′ to the outer tubular member 236′ of the reinforcing member 23′ and abutting against the outer tubular member 236′ and the outer annular web section 235′ of the reinforcing member 23′. The inner tubular member 243′ is aligned axially with the inner tubular member 233′ of the reinforcing member 23′. The collar members 244′ are adapted to be fitted in a mounting hole (not shown) in a door. The gaps 246′ between the collar members 244′ are adapted to receive and position a latch mechanism (not shown). Holes 245′ are provided in the annular plate section 241′ for extension of screw bolts (not shown) to engage the screw holes 14 of the key-operated lock unit 1. The lock case 12 is received within the slot 240′, and the key plug 15 extends through the opening 242′.

The reinforcing member 23′ has dual functions, i.e. the function of a reinforcing member per se and the function of an adaptor. When the reinforcing member 23′ is used in combination with the adaptor 24′, the reinforcing member 23′ functions as a reinforcing means, and is assembled within the inner case 21 as best shown in FIG. 10. In assembly, the outer tubular member 236′ abuts against the annular shoulder 216 and the inner annular surface of the rim section 217. An edge of the outer tubular member 236, engages the bosses 219 of the inner case 21 oppositely of the annular shoulder 216. The inner tubular member 233′ receives the lock case 12. A juncture of the outer tubular member 236′ and the outer annular web section 235′ abuts against the annular shoulder 216. A juncture of the inner annular web section 231′ and the intermediate tubular member 234′ abuts against the inner surface of the wall section 210 to provide an increased resistance to an external impact force.

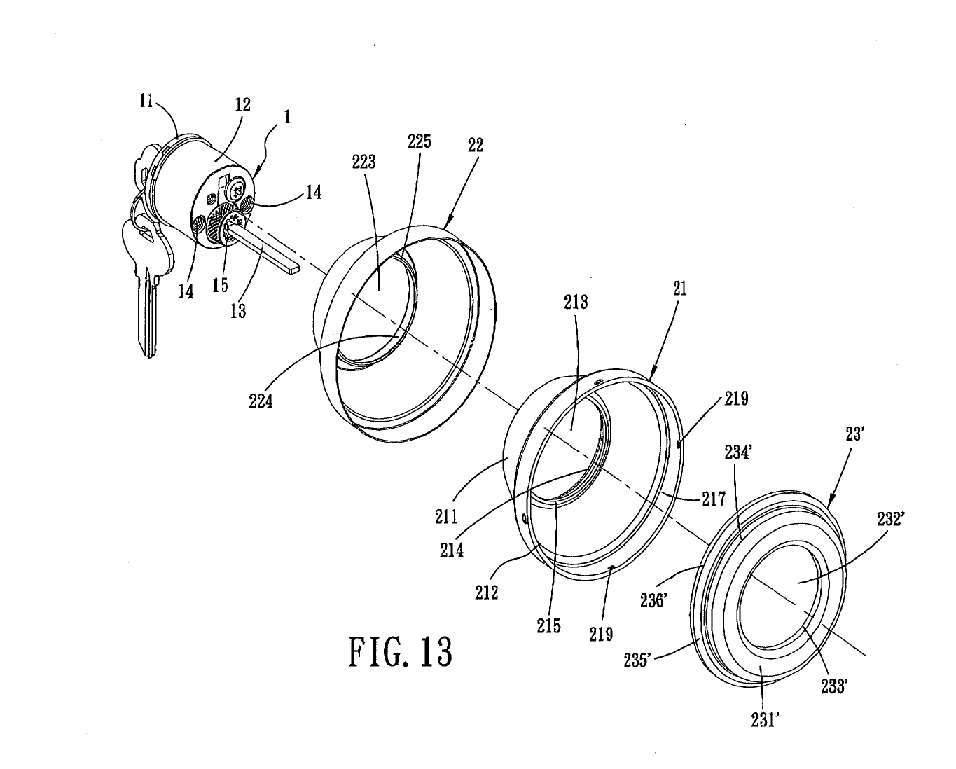

In case the reinforcing member 23′ is used as the adaptor, the reinforcing member 23′ is assembled to the inner and outer cases 21, 22 and the lock unit 1 in the absence of the adaptor 24′. Referring to FIGS. 13-16, in assembly, the position of the reinforcing member 23′ is inverted to have the configuration of the adaptor. The inner tubular member 233′, the inner annular web section 231′ and the intermediate tubular member 234′ therefore extend out of the inner case 21. The intermediate tubular member 234′ is adapted to be fitted in the mounting hole (not shown) of the door. The outer tubular member 236′ abuts against the annular shoulder 216 and the inner annular surface of the rim section 217, and the juncture of the outer tubular member 236′ and the outer annular web section 235′ abuts against the bosses 219 of the inner case 21 oppositely of the annular shoulder 216. The inner tubular member 233′ projects from the inner annular web section 231′ in a direction toward the second open end 212, and receives the lock case 12.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

We claim:

1. A deadbolt lock device for a door, comprising:
a key-operated lock unit having a lock case enclosing a key plug; and
a housing receiving said lock case, said housing including an inner case which has opposite first and second open ends, a first annular flange that projects inwardly from said first open end in a direction toward said second open end and that has an inner end extending away from said first open end, a first annular rib that projects transversely from said inner end of said first annular flange, said first annular rib defining a through hole that receives said lock case;
said first annular rib having an annular edge surrounding and disposed in proximity to said lock case, and first and second annular surfaces that are opposite to each other and that extend inclinedly to said annular edge from a juncture of said first annular flange and said first annular rib, said first and second annular surfaces being inclined with respect to a plane that intersects perpendicularly an axis of said lock case and that extends through said annular edge, said first and second annular surfaces extending inclinedly along directions inclining towards said first open end.

2. The deadbolt lock device of claim 1, further comprising an adaptor connected to said inner case in proximity to said second open end and adapted to be fitted in a mounting hole in the door, said adaptor having a slot aligned with said through hole of said inner case.

3. The deadbolt lock device of claim 1, further comprising an outer case covering said inner case and having a second annular flange extending over said first annular flange, and a second annular rib abutting against said first annular rib.

4. The deadbolt lock device of claim 1, wherein said first and second annular surfaces are inclined with respect to said plane at an angle of about 5 to 45 degrees.

5. The deadbolt lock device of claim 2, wherein said inner case further has a substantially truncated cone-shaped wall section, a rim section, and an annular shoulder interconnecting said wall section and said rim section, said wall section being tapered to said first open end, said rim section extending from said annular shoulder to said second open end, said rim section having an inner annular surface, the deadbolt lock device further comprising a reinforcing member that includes an inner tubular member extending axially relative to said lock case and defining a slot that is aligned axially with said through hole of said inner case and that receives said lock case, and an outer tubular member extending axially around said inner tubular member, said outer tubular member abutting against said adaptor, said annular shoulder, and said inner annular surface of said rim section.

6. The deadbolt lock device of claim 5, wherein said rim section has a plurality of angularly spaced apart bosses that project from said inner annular surface in proximity to said second open end and that engage said outer tubular member of said reinforcing member oppositely of said annular shoulder.

7. The deadbolt lock device of claim 6, wherein said reinforcing member further has an annular web extending radially and connected to said inner and outer tubular members, said inner tubular member having a portion extending out of said second open end.

8. The deadbolt lock device of claim 7, wherein said adaptor further has an inner tubular member defining said slot of said adaptor and sleeved around said inner tubular member of said reinforcing member, an annular plate section extending radially and outwardly from said inner tubular member of said adaptor, an outer tubular member extending around said inner tubular member of said adaptor and adapted to be fitted in the mounting hole of the door, and an annular folded and flattened plate end formed as one piece with said annular plate section and with said outer tubular member of said adaptor, said folded and flattened plate end projecting radially and outwardly from said outer tubular member of said adaptor and abutting against said bosses of said rim section and said outer tubular member of said reinforcing member.

9. The deadbolt lock device of claim 8, wherein said outer tubular member of said adaptor has two diametrically opposite notches formed therein and adapted to receive a latch mechanism.

10. The deadbolt lock device of claim 6, wherein said reinforcing member further has an outer annular web section extending inwardly and radially from said outer tubular member of said reinforcing member at a location proximate to said annular shoulder, an intermediate tubular member projecting axially from said outer annular web section to an inner surface of said wall section of said inner case, and an inner annular web section extending radially and inwardly from said intermediate tubular member to said inner tubular member of said reinforcing member.

11. The deadbolt lock device of claim 10, wherein said adaptor further includes an annular plate section disposed outwardly of said second open end of said inner case, an inner tubular member projecting axially into said rim section from said annular plate section and defining said slot, two diametrically opposite collar members projecting axially from said annular plate section in a direction away from said rim section, and an outer peripheral lip extending from said annular plate section to said outer tubular member of said reinforcing member and abutting against said outer tubular member and said outer annular web section of said reinforcing member.

12. The deadbolt lock device of claim 2, wherein said adaptor further has an outer tubular member abutting against said annular shoulder and said inner annular surface of said rim section, an outer annular web section extending radially and inwardly from said outer tubular member, an intermediate tubular member projecting axially from said outer annular web section and extending outwardly of said second open end of said inner case, an inner annular web section that projects radially from said intermediate tubular member toward said slot of said adaptor and that extends outwardly of said second open end, and an inner tubular member that projects axially from said inner annular web section in a direction toward said second open end and defining said slot of said adaptor.

13. A deadbolt lock device for a door, comprising
a key-operated lock unit having a lock case enclosing a key plug, and a housing receiving said lock case, said housing including:
an inner case which has opposite first and second open ends, a first annular flange that projects inwardly from said first open end in a direction toward said second open end, and a first annular rib that projects inwardly and transversely from said inner end of said first annular flange, said first annular rib defining a through hole that receives said lock case; and
a reinforcing member that includes an inner tubular member extending axially relative to the lock case and defining a slot that is aligned axially with said through hole of said inner case and that receives said lock case, an outer tubular member that extends axially around said inner tubular member and that abuts against an inner annular surface of said inner case in proximity to said second open end, and an annular web extending transversely of and connected to said inner and outer tubular members.

14. The deadbolt lock device of claim 13, wherein said inner case further has a substantially truncated cone-shaped wall section, a rim section and an annular shoulder interconnecting said wall section and said rim section, said wall section being tapered to said first open end, said rim section extending from said annular shoulder to said second open end, said rim section having said inner annular surface, said outer tubular member of said reinforcing member abutting against said annular shoulder and said inner annular surface of said rim section.

15. The deadbolt lock device of claim 14, wherein said reinforcing member further includes an intermediate tubular member between said inner and outer tubular members, said annular web having inner and outer annular web sections, said outer annular web section extending inwardly and radially from said outer tubular member to said intermediate tubular member, said intermediate tubular member projecting axially from said outer annular web section to an inner surface of said wall section of said inner case, said inner annular web section extending radially and inwardly from said intermediate tubular member to said inner tubular member.

16. The deadbolt lock device of claim 14, wherein said rim section has a plurality of angularly spaced apart bosses that project from said inner annular surface in proximity to said second open end and that engage said outer tubular member of said reinforcing member oppositely of said annular shoulder.

17. The deadbolt lock device of claim 13, further comprising an adaptor adapted to be fitted in a mounting hole of the door, and having an inner tubular member extending axially of said lock case and defining a slot aligned with said through hole of said inner case, and an outer periphery abutting against at least said outer tubular member of said reinforcing member.

18. The deadbolt lock device of claim 13, further comprising an outer case covering said inner case and having a second annular flange extending over said first annular flange, and a second annular rib abutting against said first annular rib.
